(19) United States
(12) Patent Application Publication
(10) Pub. No.: US 2004/0028006 A1
(43) Pub. Date: Feb. 12, 2004

(54) Random access method and radio station

(75) Inventors: Hidetoshi Kayama, Yokohama-shi (JP); Lan Chen, Yokohama-shi (JP); Daisuke Kitazawa, Yokohama-shi (JP); Narumi Umeda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/442,091

(22) Filed: May 21, 2003

(30) Foreign Application Priority Data
May 22, 2002 (JP) P2002-148054

(51) Int. Cl. H04B 7/216

(52) U.S. Cl. 370/320

(57) ABSTRACT

The object is to suppress interference to other packets under transmission and decrease the error rate of packets. A mobile station first starts transmitting a packet A stored and then starts transmitting a packet B after a predetermined period of time τₛ. Thereafter, the mobile station starts transmitting packets C, D in order at intervals of the predetermined time period τₛ. Since each packet is assigned an individual code and transmitted at a relatively low transmission rate, packets are transmitted in an overlapping state when the predetermined period τₛ is set sufficiently short. The transmission power of the mobile station is in a gently stepped state. Since the period of the transmission power control in the mobile station is set shorter than the predetermined period of time τₛ, Eb/No can be maintained at or above a required value by increasing the power of the desired wave in the transmission power control, even in the case where transmitted signals of other packets concurrently transmitted work as interference waves.

### BACKGROUND OF THE INVENTION

1. Field of the Invention

The present invention relates to a random access method and a radio station, and more particularly, to a random access method executed in a CDMA packet communication system comprising a plurality of radio stations having a function of transmitting and receiving packets on a wireless section to and from each other by code division multiple access and a function of performing transmission power control during transmission and reception of packets, and a radio station forming the CDMA packet communication system.

It should be noted that “radio stations” in the present specification encompass both base stations and mobile stations (e.g., PDA, cellular phone, PHS, portable personal computer, etc.).

2. Related Background Art

In the CDMA packet communication, different from the conventional TDMA or FDMA radio packet communications, even when a plurality of packets are simultaneously transmitted, the receiving station can decode them as long as each despread packet satisfies the required signal to interference ratio. For taking advantage of this property of CDMA, it is necessary to control an interference power to each packet to below a threshold, i.e., to control the number of packets concurrently transmitted, below a certain number. It is thus common practice to use a method of effecting the control by letting the base stations estimate the traffic by channel load sensing and transmit a transmit permission probability of a random access signal according thereto.

One of the random access methods applying it is CDMA-PRMA (Packet Reservation Multiple Access). In this method, a channel is divided into slots and a frame consists of a plurality of slots. Each packet first makes access through a randomly selected slot by slotted ALOHA and the base station side, if successfully receiving it, reserves resources of the same slots in subsequent frames, whereby it becomes feasible to transmit the rest data.

However, if interference becomes strong over a permitted interference level because of congestion of packets transmitted by slotted ALOHA, the signal to interference ratios of packets transmitted through the reserved slots will come to fail to satisfy the specified value, resulting in an extreme drop in error rates. Then, the base station calculates the transmit permission probability of packets by slotted ALOHA in each slot on the basis of the number of packets reserved in the slot, and broadcasts it to mobile stations. A mobile station determines whether channel access by slotted ALOHA to the slot should be made, based on the transmit permission probability.

On the other hand, Active Link Protection is known as a technique of protecting a link in communication. As described previously, CDMA permits a plurality of signals to be concurrently transmitted at the same frequency, while the signals other than a signal of interest exert interference powers on the signal of interest. For this reason, when a new signal B is transmitted during transmission of a certain signal A, the signal B is added as an interference wave to the signal A. If at this time the ratio of the reception power of the signal A under transmission to the interference power after the addition of the interference power due to the signal B falls below a predetermined threshold, the signal A under transmission will be likely to end in an error.

Active Link Protection adopts two approaches below to reducing such error. The first approach is a technique of performing the transmission power control so as to satisfy target Eb/No resulting from addition of a given margin to required Eb/No (the ratio of energy per bit to the spectral noise density in a digital modulation signal). This provides each signal with some resistance to variation of interference power. The second approach is a technique of increasing the transmission power stepwise from the start of transmission of signals. This makes it feasible to prevent Eb/No from falling under the required value because of the transmission power control on the link under communication, even in the case where interference increases upon occurrence of a new signal.

In the aforementioned CDMA-PRMA, the base station controls the traffic load of packets from terminals under control of its own by use of the transmit permission probability of packets, whereby it can control the interference power in an arbitrary slot so as not to exceed the permitted value. It is, however, generally the case that in mobile communication the service areas spread two-dimensionally and in CDMA the same frequency channel might be used in all the cells, and it is thus necessary to take interference powers from adjacent cells into consideration.

In the CDMA-PRMA, however, since no transmission control is made over the adjacent cells at all, there could occur a case where the required Eb/No is not assured because of the interference from the adjacent cells.

In contrast to it, Active Link Protection provides each link with some margin to the interference waves from both inside and outside the cell, and the transmission power control can handle increase and decrease of the interference waves; therefore, it is feasible to prevent the increase in the error rate due to the interference from the adjacent cells.

Even with the use of this method, however, the state of failing to ensure the required Eb/No can result if the constraints on the transmission power of the terminal cause the interference power to exceed a certain level. Particularly, in the packet communication, there can occur a case where an extremely large number of packets flock within a short period of time, so as to fail to satisfy the required Eb/No.

In addition, the transmission power is generally increased or decreased in relatively small steps during the transmission power control. Therefore, while the interference waves are largely reduced after completion of transmission of a packet having been transmitted in a large power, the other packets under transmission are continuously transmitted in higher powers than necessary during the period in which the transmission power is decreased stepwise by the transmission power control. This can be a factor of decreasing the efficiency of utilization of radio resources.

The present invention has been accomplished in order to solve the above problem and an object of the invention is to provide a random access method and a radio station, which are capable of suppressing the interference to the other packets under transmission and decreasing the error rate of packets.

### SUMMARY OF THE INVENTION

In order to achieve the above object, a random access method according to the present invention is a random access method executed in a CDMA packet communication system comprising a plurality of radio stations having a function of transmitting and receiving packets on a wireless section to and from each other by code division multiple access and a function of performing transmission power control during transmission and reception of packets, wherein, on the occasion of concurrently transmitting a plurality of packets, the radio station assigns different spreading codes to the respective packets and shifts transmission start times of the individual packets assigned the different spreading codes, each by a predetermined period of time.

A radio station according to the present invention is a radio station having a function of transmitting and receiving packets on a wireless section to and from another radio station by code division multiple access and a function of performing transmission power control during transmission and reception of packets, the radio station comprising: spreading code assigning means for, on the occasion of concurrently transmitting a plurality of packets, assigning different spreading codes to the respective packets; and start time controlling means for shifting transmission start times of the individual packets assigned the different spreading codes, each by a predetermined period of time.

According to the aspects of the invention, the transmission start times are shifted so as to transmit the packets in an overlapping state and increase the number of overlapping packets gradually from the start of transmission; therefore, the transmission power in the radio channel can be increased stepwise. For this reason, it becomes feasible to prevent excessive interference to the other packets under transmission and to secure a time enough to perform the transmission power control against increase of interference waves, thereby decreasing the error rate of packets.

In the above aspects, the predetermined period of time is desirably set longer than a period in which the transmission power control is performed. Namely, the transmission power of each packet is increased or decreased in a step greater than the period of the transmission power control, and execution of the transmission power control enables the other under-transmission packets to avoid being affected by interference waves due to the other under-transmission packets, regardless of whether a source of the interference waves is located inside or outside the cell. The execution of the above transmission power control also permits the other under-transmission packets after transmission of an arbitrary packet to avoid continuously being transmitted in transmission powers stronger than necessary, thereby increasing the frequency efficiency.

The random access method according to the present invention is desirably configured so that the radio station determines whether a total reception power in a receive channel exceeds a predetermined threshold and, when the total reception power exceeds the threshold, the radio station broadcasts a transmission regulation signal for ordering a predetermined operation of regulating packet transmission, to neighbor radio stations, and so that each neighbor radio station in transmission of packets, when receiving the transmission regulation signal, suspends transmission of a new packet or lengthens the predetermined period of time as a shift width of the transmission start times on the basis of the contents indicated by the transmission regulation signal.

The radio station according to the present invention is desirably configured to comprise reception power determining means for determining whether a total reception power in a receive channel exceeds a predetermined threshold; signal broadcasting means for, when the total reception power exceeds the threshold, broadcasting a transmission regulation signal for ordering a predetermined operation of regulating packet transmission, to neighbor radio stations; and first transmission regulation controlling means for, when receiving the transmission regulation signal from another radio station during packet transmission, performing such control as to suspend transmission of a new packet or lengthen the predetermined period of time as a shift width of the transmission start times on the basis of the contents indicated by the transmission regulation signal.

When the aspects of the invention are applied so as to suspend the packet transmission itself or lengthen the predetermined period of time as a shift width of the transmission start times, it becomes feasible to decrease the interference level in the radio channel. For example, when the receive channel suffers interference too strong to be avoided even by the transmission power control, the traffic load of the radio station is lowered to an appropriate value, whereby the error rate of packets can be prevented from seriously increasing.

In order to achieve the above object, another random access method according to the present invention is a random access method executed in a CDMA packet communication system comprising a plurality of radio stations having a function of transmitting and receiving packets on a wireless section to and from each other by code division multiple access and a function of performing transmission power control during transmission and reception of packets, wherein, on the occasion of continuously transmitting a plurality of packets, the radio station gradually increases a transmission rate of each packet.

Another radio station according to the present invention is a radio station having a function of transmitting and receiving packets on a wireless section to and from another radio station by code division multiple access and a function of performing transmission power control during transmission and reception of packets, the radio station comprising: transmission rate controlling means for, on the occasion of continuously transmitting a plurality of packets, gradually increasing a transmission rate of each packet.

According to the aspects of the invention, the transmission rate is gradually increased by making use of the fact that the required transmission power varies according to the transmission rate in the case of the CDMA packets; therefore, the transmission power in the radio channel can be increased stepwise. For this reason, it becomes feasible to prevent excessive interference to the other packets under transmission and to secure a time enough to perform the transmission power control against increase of interference waves, thereby decreasing the error rate of packets.

The random access method according to the present invention is desirably configured so that the radio station determines whether a total reception power in a receive channel exceeds a predetermined threshold and, when the total reception power exceeds the threshold, the radio station broadcasts a transmission regulation signal for ordering a predetermined operation of regulating packet transmission, to neighbor radio stations, and so that each neighbor radio station in transmission of packets, when receiving the transmission regulation signal, suspends transmission of a new packet or lowers a transmission rate of a subsequent packet on the basis of the contents indicated by the transmission regulation signal.

The radio station according to the present invention is preferably configured to comprise reception power determining means for determining whether a total reception power in a receive channel exceeds a predetermined threshold; signal broadcasting means for, when the total reception power exceeds the threshold, broadcasting a transmission regulation signal for ordering a predetermined operation of regulating packet transmission, to neighbor radio stations; and second transmission regulation controlling means for, when receiving the transmission regulation signal from another radio station during packet transmission, performing such control as to suspend transmission of a new packet or lower a transmission rate of a subsequent packet on the basis of the contents indicated by the transmission regulation signal.

When the aspects of the invention are applied so as to suspend the packet transmission itself or adjust the transmission rate, it becomes feasible to decrease the interference level in the radio channel. For example, when the receive channel suffers interference too strong to be avoided even by the transmission power control, the traffic load of the radio station is lowered to an appropriate value, whereby the error rate of packets can be prevented from seriously increasing.

In order to achieve the above object, still another random access method according to the present invention is a random access method executed in a CDMA packet communication system comprising a plurality of radio stations having a function of transmitting and receiving packets on a wireless section to and from each other by code division multiple access and a function of performing transmission power control during transmission and reception of packets, wherein, on the occasion of concurrently and continuously transmitting a plurality of packets, the radio station gradually increases the number of packets concurrently transmitted.

Still another radio station according to the present invention is a radio station having a function of transmitting and receiving packets on a wireless section to and from another radio station by code division multiple access and a function of performing transmission power control during transmission and reception of packets, the radio station comprising: number-of-transmitted-packets controlling means for, on the occasion of concurrently and continuously transmitting a plurality of packets, gradually increasing the number of packets concurrently transmitted.

According to the aspects of the invention, the number of packets concurrently transmitted is gradually increased, whereby the transmission power in the radio channel can be increased stepwise. For this reason, it becomes feasible to prevent excessive interference to the other packets under transmission and to secure a time enough to perform the transmission power control against increase of interference waves, thereby decreasing the error rate of packets.

The random access method according to the present invention is preferably configured so that the radio station determines whether a total reception power in a receive channel exceeds a predetermined threshold and, when the total reception power exceeds the threshold, the radio station broadcasts a transmission regulation signal for ordering a predetermined operation of regulating packet transmission, to neighbor radio stations, and so that each neighbor radio station in transmission of packets, when receiving the transmission regulation signal, suspends transmission of a new packet or decreases the number of packets concurrently transmitted, on the basis of the contents indicated by the transmission regulation signal.

The radio station according to the present invention is desirably configured to comprise reception power determining means for determining whether a total reception power in a receive channel exceeds a predetermined threshold; signal broadcasting means for, when the total reception power exceeds the threshold, broadcasting a transmission regulation signal for ordering a predetermined operation of regulating packet transmission, to neighbor radio stations; and third transmission regulation controlling means for, when receiving the transmission regulation signal from another radio station during packet transmission, performing such control as to suspend transmission of a new packet or decrease the number of packets concurrently transmitted, on the basis of the contents indicated by the transmission regulation signal.

When the aspects of the invention are applied so as to suspend the packet transmission itself or decrease the number of packets simultaneously transmitted, it becomes feasible to decrease the interference level in the radio channel. For example, when the receive channel suffers interference too strong to be avoided even by the transmission power control, the traffic load of the radio station is lowered to an appropriate value, whereby the error rate of packets can be prevented from seriously increasing.

Incidentally, the present invention can also be captured from an aspect of the invention directed to a CDMA packet communication system, as well as the random access methods and radio stations. Namely a CDMA packet communication system according to the present invention comprises a plurality of radio stations; each of them is one of the radio stations described above.

### BRIEF DESCRIPTION OF THE DRAWINGS

FIG. 1 is a system configuration diagram in the first to third embodiments.

FIG. 2A is a configuration diagram of the mobile station in the first embodiment.

FIG. 2B is a configuration diagram of the mobile station in the second embodiment.

FIG. 2C is a configuration diagram of the mobile station in the third embodiment.

FIG. 3 is a diagram showing the packet transmission operation in the first embodiment.

FIG. 4 is a diagram showing the operation of packet transmission regulation in the first embodiment.

FIG. 5 is a table showing the relationship of signal types with the packet transmit permission probabilities and suspension times in the first embodiment.

FIG. 6 is a chart showing the transmission operation of the mobile station in the first embodiment.

FIG. 7 is a diagram showing the packet transmission operation in the second embodiment.

FIG. 8 is a diagram showing the operation of packet transmission regulation in the second embodiment.

FIG. 9 is a table showing the relationship of signal types with the maximum transmission rates and transmit permission probabilities in the second embodiment.

FIG. 10 is a chart showing the transmission operation of the mobile station in the second embodiment.

FIG. 11 is a diagram showing the packet transmission operation in the third embodiment.

FIG. 12 is a diagram showing the operation of packet transmission regulation in the third embodiment.

FIG. 13 is a table showing the relationship of signal types with the maximum numbers of simultaneously transmitted packets and transmit permission probabilities in the third embodiment.

FIG. 14 is a diagram showing the transmission operation of the mobile station in the third embodiment.

### DESCRIPTION OF THE PREFERRED EMBODIMENTS

A variety of embodiments of the present invention will be described below.

[First Embodiment]

The first embodiment will describe an embodiment according to the present invention directed to the first random access method and to the radio station and CDMA communication system corresponding thereto.

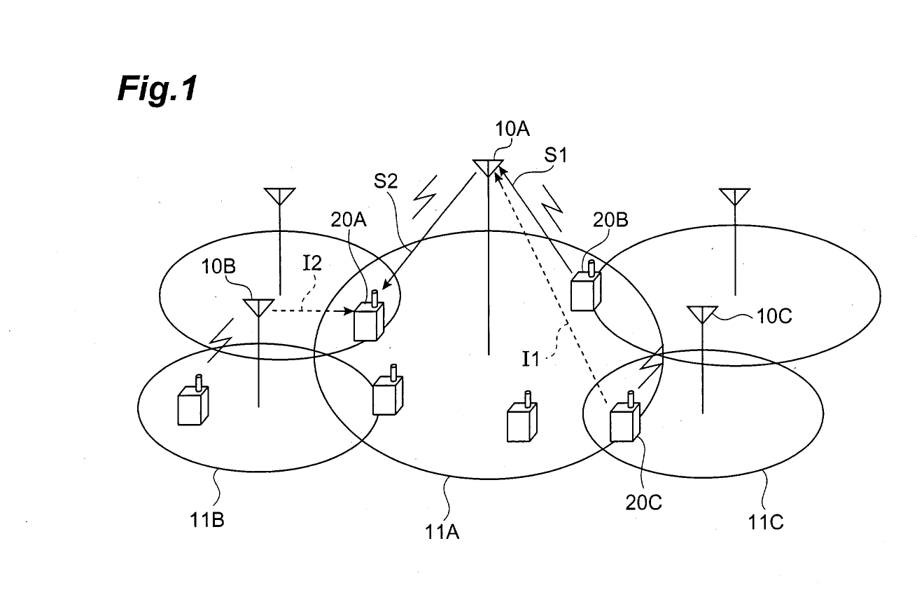

FIG. 1 shows a configuration example of the CDMA communication system according to the present embodiment. In this system, radio stations 10 (e.g., radio stations 10A, 10B, 10C, . . . ) with a base-station function form their respective cells 11A, 11B, and 11C. In the description hereinafter, the radio stations 10 with the base-station function will be referred to as “base stations 10” for convenience' sake of description, and it is noted that the radio stations encompass both the so-called base stations, and mobile stations with the base-station function. The mobile stations with the base-station function use this function on the occasion of transmitting a received signal to another radio station.

Each cell accommodates one or more mobile stations 20 (e.g.,mobile stations 20A, 20B, 20C, . . . ), and each mobile station 20 is performing packet communication on CDMA channels with the base station 10 forming the cell to which the mobile station 20 in question belongs. Here the CDMA channels use the same frequency in all the cells and, for this reason, for example, at the base station 10A a desired wave S1 from the mobile station 20B in its own cell 11A can interfere with an interference wave I1 from the mobile station 20C in the adjacent cell 11C. As for downlinks (in the direction from the base station to the mobile station), for example, at the mobile station 20A belonging to the cell 11A, a desired wave S2 from the base station 10A can also interfere with an interference wave I2 from the base station 10B in the adjacent cell 11B.

The radio stations according to the present invention correspond to all stations performing radio packet transmission in the above communication system of FIG. 1 (including both the base stations and mobile stations), and in the embodiment below, the packet transmission control operation in the mobile station 20 will be described as an operation associated with the random access method according to the present invention.

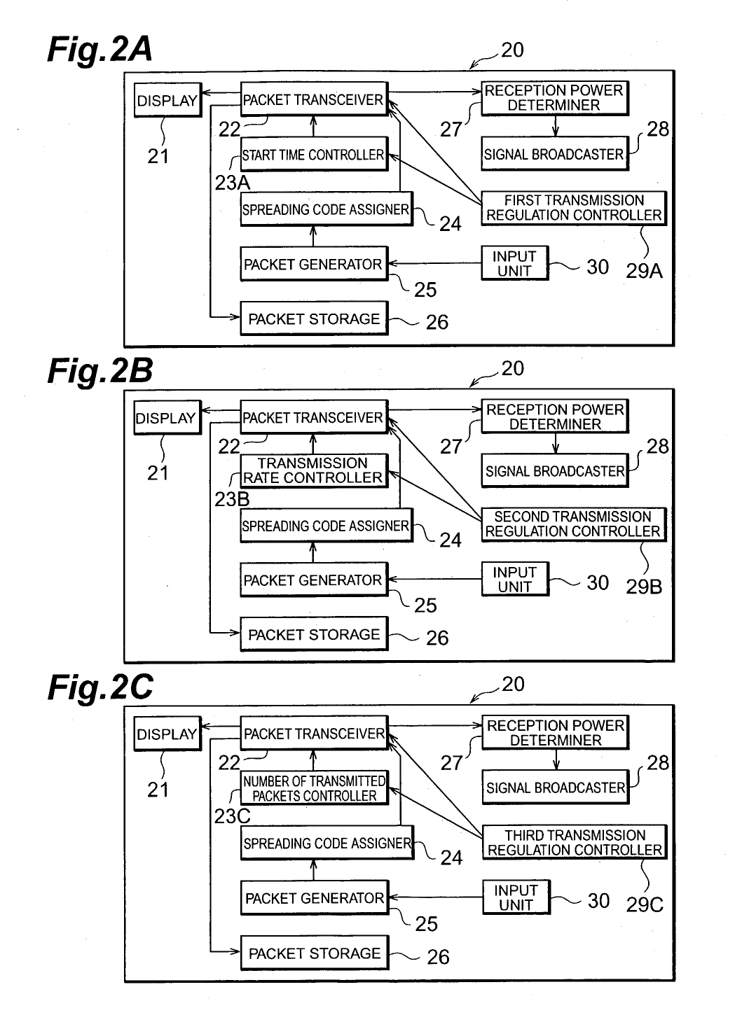

FIG. 2A shows a configuration according to the present invention in the mobile station 20 of the present embodiment. As shown in this FIG. 2A, the mobile station 20 has a function of carrying out the packet communication in the CDMA system and a function of performing the transmission power control during transmission and reception of packets, and is provided with the following components. Namely, the mobile station 20 is comprised of: an input unit 30 for execution of predetermined instruction operation, input operation, etc. about packet transmission; a packet generator 25 incorporating a transmission buffer and configured to generate packets to be transmitted (transmitted packets) and store them in the transmission buffer; a packet transceiver 22 provided with a plurality of channels and configured to transmit and receive packets on a wireless section to and from another radio station by code division multiple access; a spreading code assigner 24 configured to, on the occasion of concurrently transmitting a plurality of packets, assign different spreading codes to the respective packets; a start time controller 23A for performing such control as to shift transmission start times of the individual packets assigned the different spreading codes, each by a predetermined period of time; a reception power determiner 27 for determining whether a total reception power in a receive channel exceeds a predetermined threshold; a signal broadcaster 28 for, when it is determined that the total reception power became over the threshold, broadcasting a transmission regulation signal for ordering a predetermined operation of regulating packet transmission, to neighbor radio stations; a first transmission regulation controller 29A for, when receiving the transmission regulation signal from another radio station during packet transmission, performing such control as to suspend transmission of a new packet or lengthen the predetermined period of time as a shift width of the transmission start times on the basis of the contents indicated by the transmission regulation signal; a packet storage 26 for storing received packet data; and a display unit 21 for displaying the contents of the received packet data.

The above configuration is characterized in that the predetermined period of time, which is equivalent to a shift amount of the packet transmission start times by the start time controller 23A, is set longer than the period in which the transmission power control is performed.

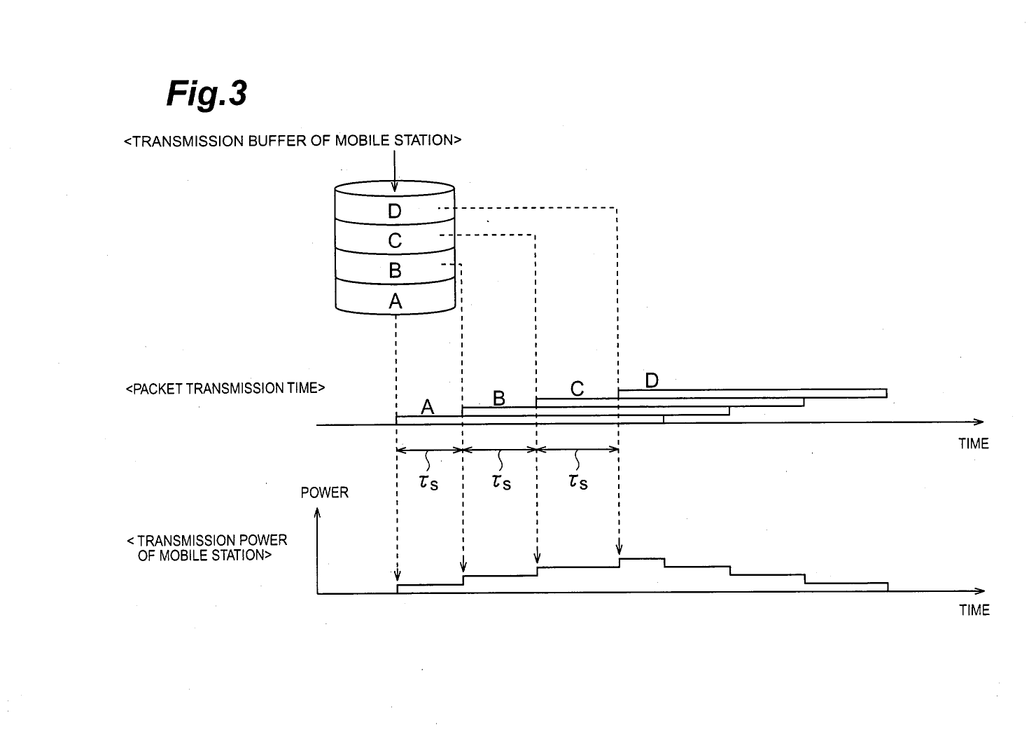

FIG. 3 shows the operation of packet transmission in the present embodiment. Now let us suppose that transmitted packets A to D are stored in the transmission buffer in the packet generator 25 of the mobile station 20, as shown in the upper part of FIG. 3. As shown in the middle part of FIG. 3, the mobile station 20 first starts transmitting the packet A and then starts transmitting the packet B after a predetermined period of time Is. Thereafter, the mobile station starts transmitting the packets C, D in order at intervals of the same predetermined time period τₛ.

Here each packet is assigned an individual code and each packet is transmitted at a relatively low transmission rate; therefore, when the predetermined time period τₛ is set sufficiently short, the packets are transmitted in an overlapping state and the transmission power of the mobile station 20 is in a gently stepped state, as shown in the lower part of FIG. 3. In the present embodiment, since the period of the transmission power control is set shorter than the foregoing predetermined period of time τₛ, Eb/No can be maintained at or above the required value by increasing the power of the desired wave in the transmission power control, even in the case where the transmitted signals of the other packets concurrently transmitted work as interference waves.

Although the present embodiment describes the transmission from the mobile station 20, it is needless to mention that this transmission method is also applicable to transmission from the base station 10.

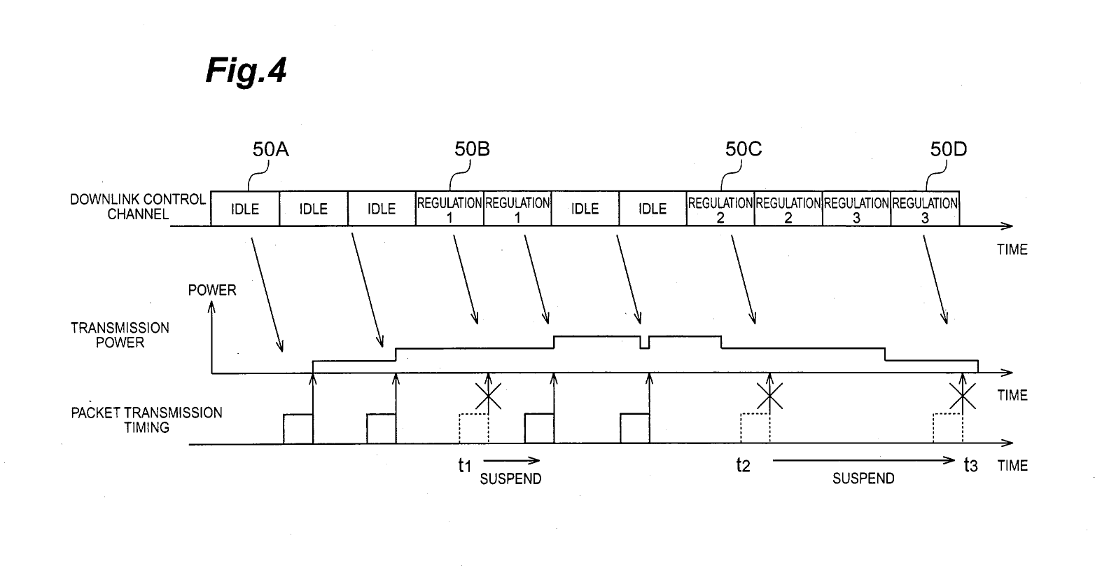

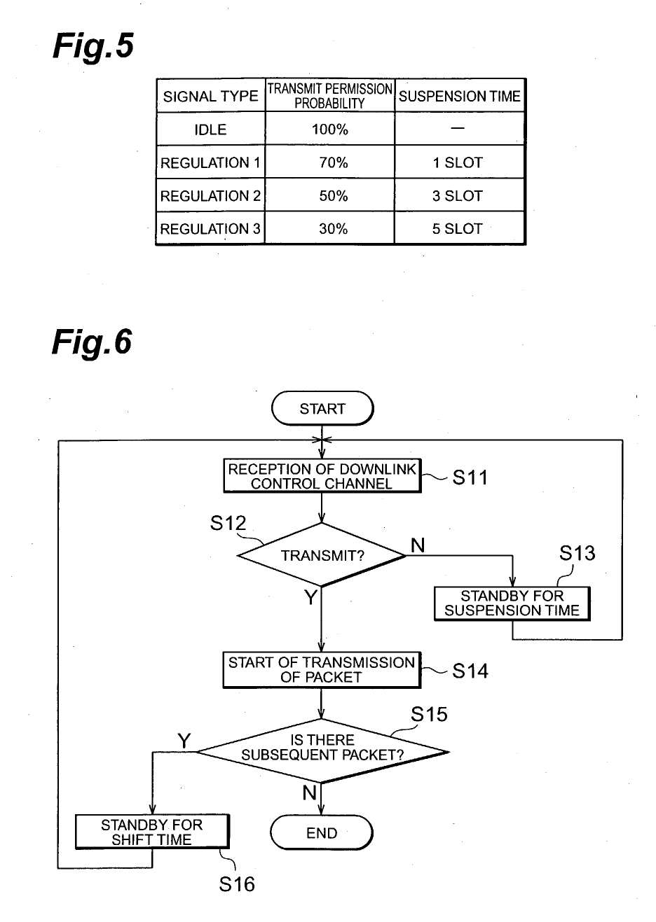

The outline of the operation for preventing abnormal increase of the interference waves due to congestion of packets will be described below with reference to FIGS. 4 and 5. The base station 10 broadcasts a downlink control channel shown in the upper part of FIG. 4, and the base station 10 selectively transmits one of an idle control signal 50A, a control signal 50B of regulation 1, a control signal 50C of regulation 2, and a control signal 50D of regulation 3 according to the intensity of the reception power in an uplink channel.

The mobile station 20 refers to the broadcast control signal upon transmission of a packet and controls the transmission of the packet, based on control information about a transmit permission probability and a suspension time for suspension of transmission as described in FIG. 5.

For example, on the occasion of transmission at the transmission timing t1 in the lower part of FIG. 4, the mobile station 20 confirms that the control signal SOB of regulation 1 is broadcast in the downlink control channel, and determines whether to immediately transmit the packet or to suspend the transmission thereof, on the basis of a random number generated inside. When the transmission is suspended, the mobile station 20 stands by for the suspension time (one slot in the case of the control signal of regulation 1 as shown in FIG. 5), and again determines whether to transmit the packet or to suspend the transmission, on the basis of a new control signal.

Of course, much the same measure is also taken with the control signal 50C of regulation 2 and the control signal 50D of regulation 3. For example, on the occasion of transmission at the transmission timing t2, the mobile station 20 confirms that the control signal 50C of regulation 2 is broadcast in the download control channel, and determines whether to immediately transmit the packet or to suspend the transmission thereof, on the basis of a random number generated inside. When the transmission is suspended, the mobile station 20 stands by for the suspension time (three slots in the case of the control signal of regulation 2 as shown in FIG. 5).

As a consequence, the transmission power of the mobile station 20 varies stepwise as shown in the middle part of FIG. 4. In addition, the transmission power is controlled at a low level during periods in which the regulation signal of regulations 1-3 is broadcast because of high degree of interference.

The transmission procedure of the mobile station 20 will be described below with reference to FIG. 6. Prior to transmission of a packet, the mobile station 20 receives the downlink control channel (S11) and determines whether to transmit the packet or to suspend the transmission thereof, based on the transmit probability of FIG. 5 corresponding to the regulation signal broadcast at that point from the base station 10 and based on a random number generated in the mobile station 20 (S12). When the mobile station 20 determines the suspension of transmission herein, the mobile station 20 stands by for the suspension time of FIG. 5 corresponding to the foregoing regulation signal (S13). After the standby, the mobile station 20 returns to S11 to repeat the transmission operation on the basis of the signal of the downlink control channel.

On the other hand, when the mobile station 20 determines execution of transmission in S12, the mobile station 20 immediately starts transmitting the packet (S14) and then determines whether there is a subsequent packet (S15). When there is a subsequent packet, the mobile station 20 stands by for the predetermined period of time (the shift time) (S16). After the standby, the mobile station 20 returns to S11 to repeat the transmission operation on the basis of the signal of the downlink control channel.

The above operation of FIG. 6 is characterized in that it is carried out before completion of transmission of a packet and concurrently in tandem with transmission of the packet. If there is no subsequent packet in S15, the processing of FIG. 6 is terminated.

In the first embodiment above, the shift of the transmission start times causes the packets to be transmitted in an overlapping state, and the number of overlapping packets gradually increases from the start of transmission; therefore, the transmission power in the radio channel can be increased stepwise. Namely, the present embodiment utilizes the suspension time and the shift time separately and S13 is configured to stand by for the suspension time, thereby achieving the peculiar effect that it is feasible to avoid the congestion of packet transmissions and to prevent excessive interference to the other packets under transmission. In addition, S16 is configured to stand by for the shift time, thereby achieving the peculiar effect that it is feasible to secure the time enough to execute the transmission power control consistent with increase of interference waves and thereby decrease the error rate of packets.

Since the shift amount of the transmission time (shift time) is set longer than the period of the transmission power control, the transmission power of each packet increases or decreases in a step greater than the period of the transmission power control. When the other packets under transmission are subjected to the transmission power control, the influence of interference waves due to the other packets under transmission can be avoided, regardless of whether the source of the interference waves is located inside or outside the cell. It is also feasible to avoid, after transmission of an arbitrary packet, continuously transmitting the other packets under transmission in the transmission powers stronger than necessary and thereby increase the frequency efficiency.

It also becomes feasible to decrease the interference level in the radio channel, by suspending the transmission of the packet or lengthening the shift time as a shift width of the transmission start times according to the regulation signal. For example, in the case where the receive channel suffers too strong interference to be avoided even by the transmission power control, the traffic load of the radio station is lowered down to an appropriate value, which can prevent the error rate of packets from seriously increasing.

[Second Embodiment]

The second embodiment will describe an embodiment of the invention directed to the second random access method and to the radio station and CDMA communication system corresponding thereto. A system configuration example assumed herein is the one shown in FIG. 1, as in the first embodiment.

FIG. 2B shows a configuration according to the present invention in the mobile station 20 of the present embodiment. When compared with the aforementioned configuration of the first embodiment, the mobile station 20 shown in this FIG. 2B is provided with a transmission rate controller 23B for, on the occasion of continuously transmitting a plurality of packets, performing such control as to gradually increase the transmission rate of each packet, instead of the start time controller 23A. The mobile station 20 is also provided with a second transmission regulation controller 29B for, when receiving a transmission regulation signal from another radio station during packet transmission, performing such control as to suspend transmission of a new packet or lower the transmission rate of a subsequent packet on the basis of the contents indicated by the transmission regulation signal, instead of the first transmission regulation controller 29A.

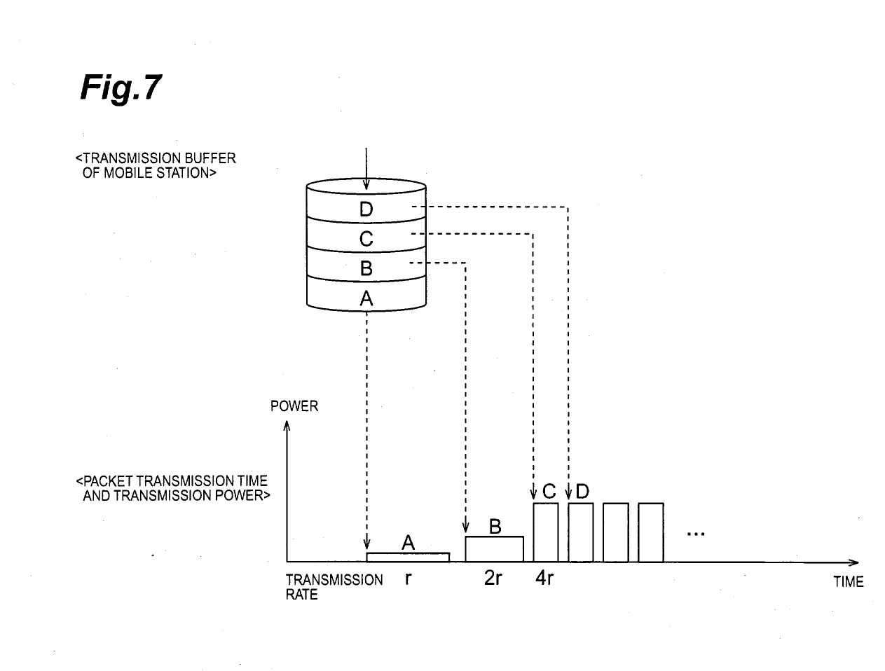

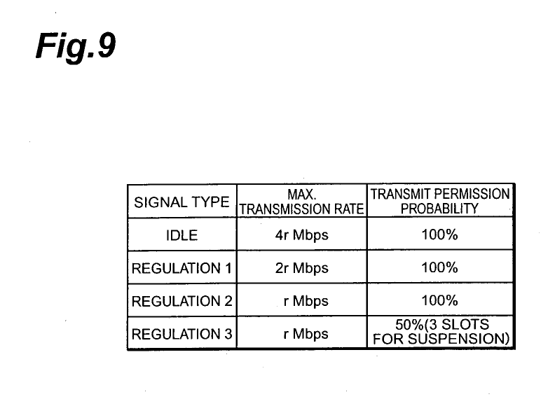

FIG. 7 shows the operation of packet transmission in the present embodiment. Now let us suppose that transmitted packets A to D are stored in the transmission buffer in the packet generator 25 of the mobile station 20, as shown in the upper part of FIG. 7. As shown in the lower part of FIG. 7, the mobile station 20 first transmits the packet A at an initial transmission rate r preliminarily determined. Then the mobile station 20 transmits the packet B at a rate equal to double the initial transmission rate r. Thereafter, the mobile station 20 continuously transmits packets while gradually increasing the transmission rate so as to double the packet transmission rate immediately before up to the maximum transmission rate shown in FIG. 9. Although this example shows the increase of the transmission rate per transmitted packet, it is also possible to employ a method of increasing the transmission rate per two, four, eight, . . . transmitted packets in consideration of the period of the transmission power control, because the packet transmission time becomes shorter with increase of the transmission rate.

As a consequence, as shown in the lower part of FIG. 7, the transmission power of the mobile station 20 is in a gently stepped state, as in the case of the first embodiment.

Although the present embodiment describes the transmission from the mobile station 20, it is needless to mention that this transmission method is also applicable to transmission from the base station 10.

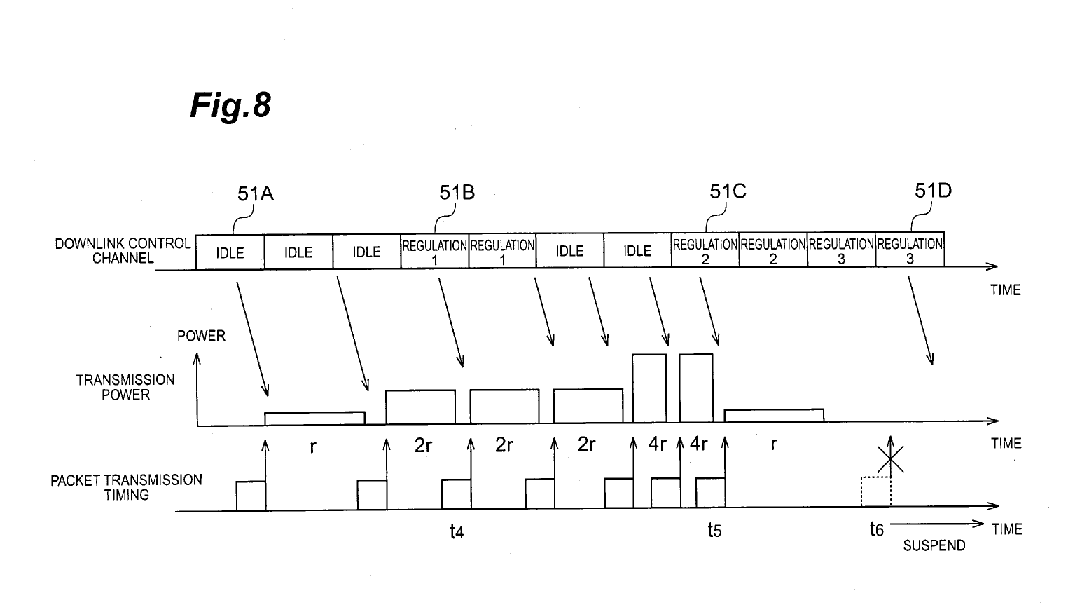

The outline of the operation for preventing abnormal increase of the interference waves due to congestion of packets will be described below with reference to FIGS. 8 and 9. The base station 10 broadcasts the downlink control channel shown in the upper part of FIG. 8, and the base station 10 selectively transmits one of an idle control signal 51A, a control signal 51B of regulation 1, a control signal 51C of regulation 2, and a control signal 51D of regulation 3 according to the intensity of the reception power in the uplink channel.

The mobile station 20 refers to the broadcast control signal upon transmission of each packet and performs the packet transmission while adjusting the transmission rate so that it falls within a range below the maximum transmission rate described in FIG. 9 and becomes equal to double the packet transmission rate immediately before, as described previously.

For example, on the occasion of transmission at the transmission timing t4 in the lower part of FIG. 8, the mobile station 20 confirms that the control signal 51B of regulation 1 is broadcast in the downlink control channel, and, because the maximum transmission rate is defined as 2r in FIG. 9, the mobile station 20 continues to transmit the next packet at the transmission rate 2r as well, though the packet transmission rate immediately before is 2r.

When confirming that the control signal 51C of regulation 2 is broadcast at the transmission timing t5, the mobile station 20 transmits the next packet at the transmission rate lowered from 4r to r, because the maximum transmission rate is defined as r in FIG. 9, though the packet transmission rate immediately before is 4r.

When it is confirmed that the control signal 51D of regulation 3 is broadcast at the transmission timing t6, the transmit permission probability is taken into consideration, in addition to the transmission rate, with reference to FIG. 9 and, as in the case of the first embodiment, the mobile station 20 determines whether to immediately transmit the packet or to suspend the transmission thereof, on the basis of a random number generated inside. When the transmission is suspended, the mobile station 20 stands by for the suspension time (three slots in the case of the control signal of regulation 3 as shown in FIG. 9) and then again determines whether to transmit the packet or to suspend the transmission thereof, on the basis of a new control signal.

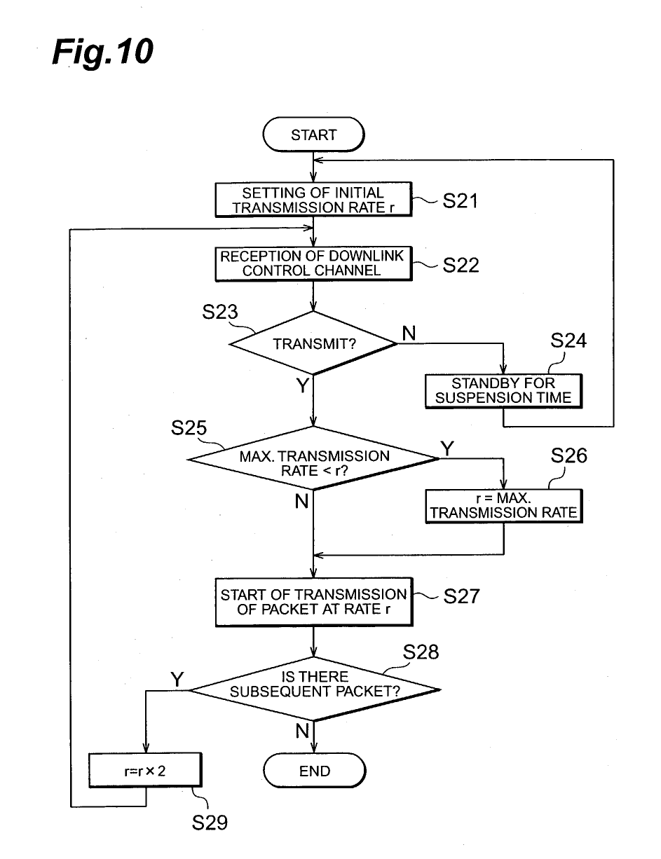

The transmission procedure of the mobile station 20 will be described below with reference to FIG. 10. Prior to transmission of a packet, the mobile station 20 first sets the initial transmission rate r (S21) and then receives the downlink control channel (S22). The mobile station 20 determines whether to transmit the packet or to suspend the transmission thereof, based on the transmit probability of FIG. 9 corresponding to the regulation signal broadcast at that point from the base station 10 and based on a random number generated in the mobile station 20 (S23). When the mobile station 20 determines the suspension herein, it stands by for the suspension time of FIG. 9 (three slots in the case of the control signal of regulation 3) corresponding to the above regulation signal (S24). After the standby, the mobile station 20 returns to S21 to repeat the transmission operation from the setting of the initial transmission rate.

On the other hand, when the mobile station 20 determines execution of the transmission in S23, it determines whether the transmission rate (r) set at this point exceeds the maximum transmission rate (S25). When the transmission rate (r) exceeds the maximum transmission rate herein, the mobile station 20 sets the transmission rate (r) to the maximum transmission rate defined in FIG. 9 (S26). This makes it feasible to keep the transmission rate (r) from exceeding the maximum transmission rate.

Then the mobile station 20 starts transmitting the packet at the transmission rate (r) set at this point (S27), and determines whether there is a subsequent packet (S28). When there is a subsequent packet, the mobile station 20 sets the transmission rate to double the transmission rate (r) set at this point (S29). After the setting, the mobile station 20 returns to S22 to repeat the transmission operation on the basis of the signal of the downlink control channel. When there is no subsequent packet in S28, the processing of FIG. 10 is terminated.

In the second embodiment above, the transmission rate is gradually increased by making use of the fact that the required transmission power varies according to the transmission rate in the CDMA packets; therefore, the transmission power in the radio channel can be increased stepwise. For this reason, it becomes feasible to prevent excessive interference to the other packets under transmission and also to secure the time enough to execute the transmission power control consistent with increase of interference waves, whereby the error rate of packets can be decreased.

By performing the control to suspend the packet transmission itself or adjust the transmission rate, it becomes feasible to decrease the interference level in the radio channel. For example, in the case where the receive channel suffers too strong interference to be avoided even by the transmission power control, the traffic load of the mobile station 20 is lowered down to an appropriate value, whereby the error rate of packets can be prevented from seriously increasing.

[Third Embodiment]

The third embodiment will describe an embodiment according to the present invention directed to the third random access method and to the radio station and CDMA communication system corresponding thereto. A system configuration example assumed herein is the one shown in FIG. 1, as in the first embodiment.

FIG. 2C shows a configuration according to the present invention in the mobile station 20 in the present embodiment. When compared with the aforementioned configuration of the first embodiment, the mobile station 20 shown in this FIG. 2C is provided with a number-of-transmitted-packets controller 23C for, on the occasion of concurrently and continuously transmitting a plurality of packets, gradually increasing the number of packets concurrently transmitted, instead of the start time controller 23A. The mobile station 20 is also provided with a third transmission regulation controller 29C for, when receiving a transmission regulation signal from another radio station during packet transmission, performing such control as to suspend transmission of a new packet or decrease the number of packets simultaneously transmitted, on the basis of the contents indicated by the transmission regulation signal, instead of the first transmission regulation controller 29A.

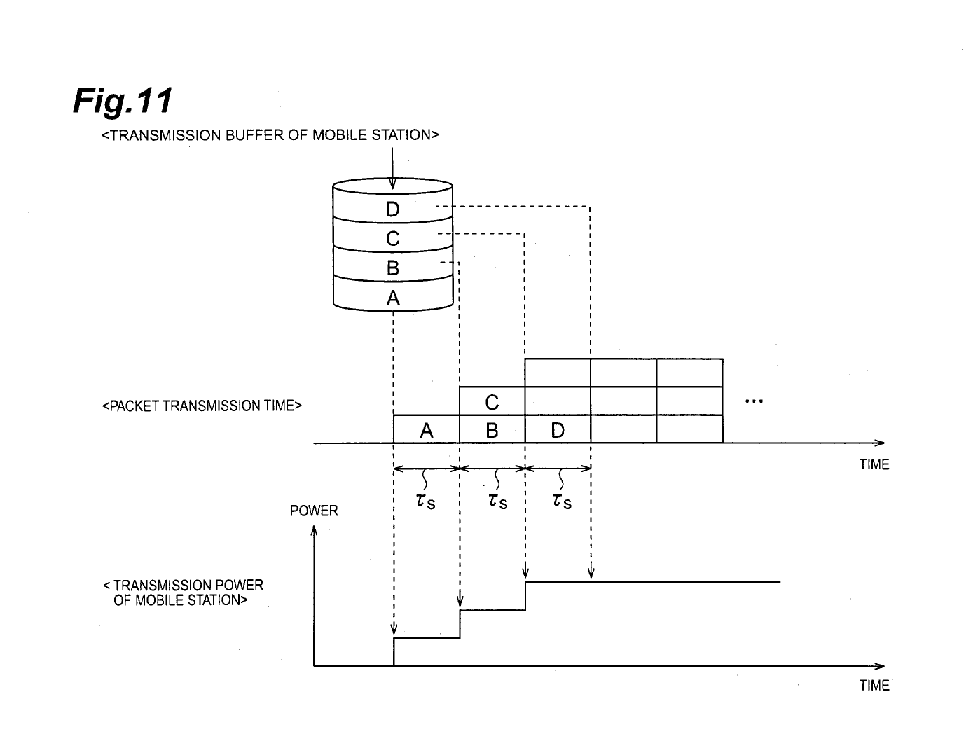

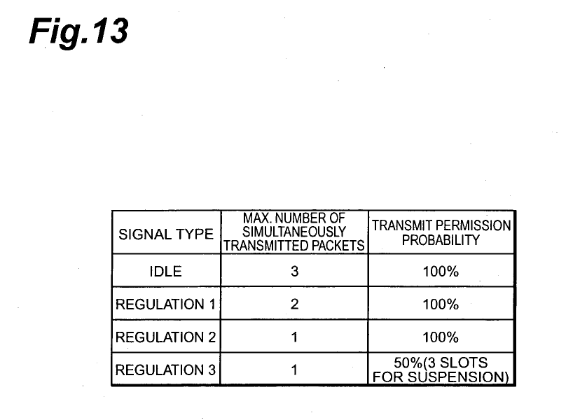

FIG. 11 shows the operation of packet transmission in the present embodiment. Now let us suppose that transmitted packets A to D are stored in the transmission buffer in the packet generator 25 of the mobile station 20, as shown in the upper part of FIG. 11. As shown in the middle part of FIG. 11, the mobile station 20 first sets the packet multiplicity to the initial number of transmitted packets preliminarily determined (one herein) and starts transmitting the packet A. After the predetermined time τₛ, the mobile station 20 sets the packet multiplicity to “the initial number of transmitted packets +1” and starts transmitting packets (packets B, C). Thereafter, before arrival at the maximum number of simultaneously transmitted packets shown in FIG. 13, packets are code-multiplexed by the number resulting from addition of 1 to the packet multiplicity immediately before, and transmission of packets is continuously carried out while gradually increasing the packet multiplicity. The packet multiplicity is increased by one per packet transmission herein, but it is also possible to adopt a method of increasing the packet multiplicity every n packet transmissions (n is an integer greater than 2), in consideration of the period of the transmission power control.

As a consequence, as shown in the lower part of FIG. 11, the transmission power of the mobile station 20 is in a gently stepped state, as in the first embodiment.

Although the present embodiment describes the transmission from the mobile station 20, it is needless to mention that this transmission method is also applicable to transmission from the base station 10.

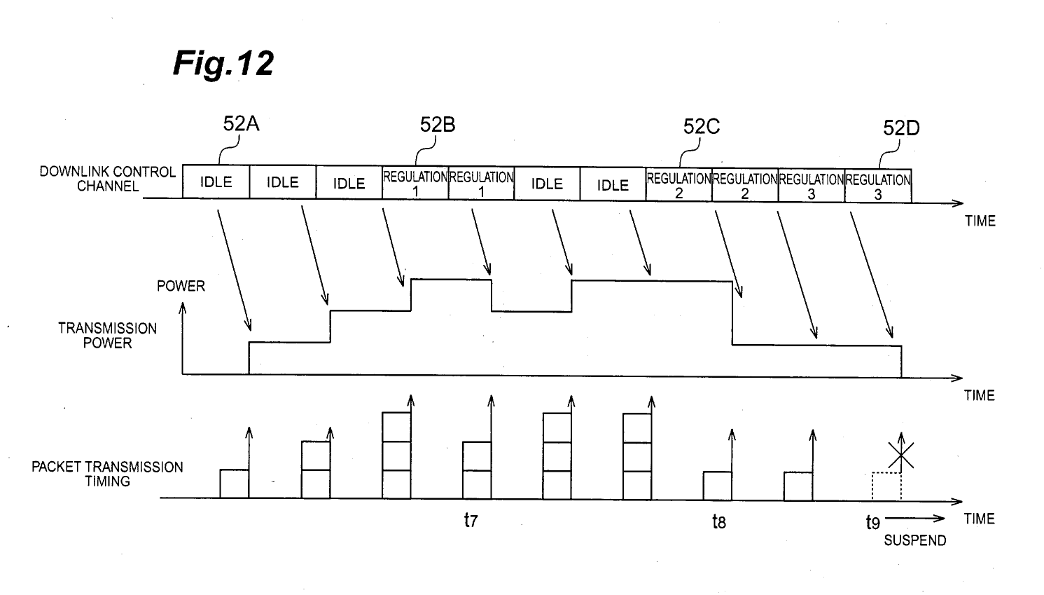

The outline of the operation for preventing abnormal increase of the interference waves due to congestion of packets will be described below with reference to FIGS. 12 and 13. The base station 10 broadcasts the downlink control channel shown in the upper part of FIG. 12, and the base station 10 selectively transmits one of an idle control signal 52A, a control signal 52B of regulation 1, a control signal 52C of regulation 2, and a control signal 52D of regulation 3 according to the intensity of the reception power in the uplink channel.

The mobile station 20 refers to the broadcast control signal upon transmission of a packet and transmits the packet while adjusting the number of simultaneously transmitted packets in the range below the maximum number of simultaneously transmitted packets described in FIG. 13 and to “the number of simultaneously transmitted packets +1” of the packet(s) immediately before, as described previously.

For example, on the occasion of transmission at the transmission timing t7 in the lower part of FIG. 12, the mobile station 20 confirms that the control signal 52B of regulation 1 is broadcast in the downlink control channel. Since the maximum number of simultaneously transmitted packets is defined as 2 in FIG. 13, the mobile station 20 transmits the packets while setting the number of simultaneously transmitted packets to 2 on the basis of the rule of FIG. 13, though the number of simultaneously transmitted packets immediately before is 3.

When it is confirmed that the control signal 52C of regulation 2 is broadcast at the transmission timing t8, though the number of simultaneously transmitted packets immediately before is 3, the mobile station 20 transmits the packet while setting the number of simultaneously transmitted packets to 1 on the basis of the rule of FIG. 13, because the maximum number of simultaneously transmitted packets is defined as 1 in FIG. 13.

When it is confirmed that the control signal 52D of regulation 3 is broadcast at the transmission timing t9, the mobile station 20 gives consideration to the transmit permission probability, in addition to the transmission rate, with reference to FIG. 13, and determines whether to immediately transmit the packet or to suspend the transmission thereof, on the basis of a random number generated inside, as in the first embodiment. When the transmission is suspended, the mobile station 20 stands by for the suspension time (three slots in the case of the control signal of regulation 3 as shown in FIG. 13) and then again determines whether to transmit it or to suspend on the basis of a new control signal.

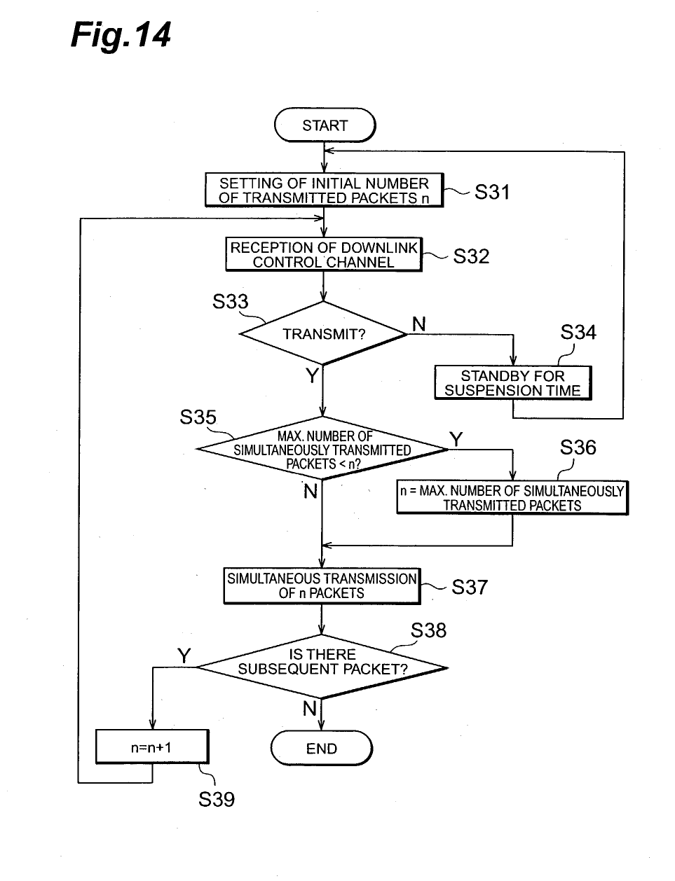

The transmission procedure of the mobile station 20 will be described below with reference to FIG. 14. Prior to transmission of a packet, the mobile station 20 first sets the initial number of transmitted packets n (S31) and then receives the downlink control channel (S32). The mobile station 20 then determines whether to perform the transmission or to suspend the transmission, based on the transmit probability of FIG. 13 corresponding to the regulation signal broadcast at this point from the base station 10 and based on a random number generated in the mobile station 20 (S33). When the mobile station 20 determines the suspension herein, the mobile station 20 stands by for the suspension time of FIG. 13 (three slots in the case of the control signal of regulation 3) corresponding to the above regulation signal (S34). After the standby, the mobile station 20 returns to S31 to repeat the transmission operation from the setting of the initial number of transmitted packets.

On the other hand, when the mobile station 20 determines execution of the transmission in S33, it determines whether the number of simultaneously transmitted packets (n) set at this point exceeds the maximum number of simultaneously transmitted packets (S35). If the number of simultaneously transmitted packets (n) exceeds the maximum number of simultaneously transmitted packets, the number (n) is set to the maximum number defined in FIG. 13 (S36). This makes it feasible to keep the number of simultaneously transmitted packets (n) from exceeding the maximum number of simultaneously transmitted packets.

Then the mobile station 20 starts transmitting packets by the number of simultaneously transmitted packets (n) set at this point (S37) and then determines whether there is a subsequent packet (S38). When there is a subsequent packet, the number of simultaneously transmitted packets (n) is reset by adding 1 to the number of simultaneously transmitted packets (n) (S39). After the setting, the mobile station 20 returns to S32 to repeat the transmission operation on the basis of the signal of the downlink control channel. When there is no subsequent packet in S38, the processing of FIG. 14 is terminated.

In the third embodiment above, the number of packets concurrently transmitted is gradually increased, whereby the transmission power in the radio channel can be increased stepwise. For this reason, it becomes feasible to prevent excessive interference to the other packets under transmission and also to secure the time enough to execute the transmission power control consistent with increase of interference waves, whereby the error rate of packets can be decreased.

By performing the control to suspend the packet transmission itself or decrease the number of packets simultaneously transmitted, it becomes feasible to decrease the interference level in the radio channel. For example, when the receive channel suffers too strong interference to be avoided even by the transmission power control, it becomes feasible to prevent the error rate of packets from seriously increasing, by decreasing the traffic load of the mobile station 20 to an appropriate value.

In the above first to third embodiments, the packet transmission control operations in the mobile station 20 were described as operations associated with the random access methods according to the present invention, but such operations are applicable to all the radio stations (including the base stations 10) configured to implement packet transmission in the CDMA packet communication system, while achieving like operation and effect.

According to the present invention, as described above, the transmission power in the channel can be increased stepwise in the CDMA packet communication system in which the frequency is shared by radio stations inside and outside the cell, whereby it becomes feasible to prevent excessive interference to packets under transmission and also to secure the time enough to execute the transmission power control consistent with increase of interference waves; therefore, it is feasible to decrease the error rate of packets.

By providing the means for controlling the packet traffic, it becomes feasible to avoid a state in which packets are heavily congested within a short period of time so that signals cannot be transmitted even at the maximum output because of increase of interference.

Furthermore, according to the invention, the transmission power is decreased stepwise both in the start period of packet transmission and in the end period of packet transmission and each radio station performs the transmission power control in conjunction therewith, whereby it is feasible to prevent occurrence of a state in which the transmission output becomes higher than necessary, and to increase the channel efficiency.

What is claimed is:

1. A random access method executed in a CDMA packet communication system comprising a plurality of radio stations having a function of transmitting and receiving packets on a wireless section to and from each other by code division multiple access and a function of performing transmission power control during transmission and reception of packets,
wherein, on the occasion of concurrently transmitting a plurality of packets, the radio station assigns different spreading codes to the respective packets and shifts transmission start times of the individual packets assigned the different spreading codes, each by a predetermined period of time.

2. A random access method executed in a CDMA packet communication system comprising a plurality of radio stations having a function of transmitting and receiving packets on a wireless section to and from each other by code division multiple access and a function of performing transmission power control during transmission and reception of packets,
wherein, on the occasion of continuously transmitting a plurality of packets, the radio station gradually increases a transmission rate of each packet.

3. A random access method executed in a CDMA packet communication system comprising a plurality of radio stations having a function of transmitting and receiving packets on a wireless section to and from each other by code division multiple access and a function of performing transmission power control during transmission and reception of packets,
wherein, on the occasion of concurrently and continuously transmitting a plurality of packets, the radio station gradually increases the number of packets concurrently transmitted.

4. The random access method according to claim 3, wherein the radio station determines whether a total reception power in a receive channel exceeds a predetermined threshold and, when the total reception power exceeds the threshold, the radio station broadcasts a transmission regulation signal for ordering a predetermined operation of regulating packet transmission, to neighbor radio stations, and
wherein each neighbor radio station in transmission of packets, when receiving the transmission regulation signal, suspends transmission of a new packet or decreases the number of packets concurrently transmitted, on the basis of the contents indicated by the transmission regulation signal.

5. A radio station having a function of transmitting and receiving packets on a wireless section to and from another radio station by code division multiple access and a function of performing transmission power control during transmission and reception of packets, said radio station comprising:
spreading code assigning means for, on the occasion of concurrently transmitting a plurality of packets, assigning different spreading codes to the respective packets; and
start time controlling means for shifting transmission start times of the individual packets assigned the different spreading codes, each by a predetermined period of time.

6. The radio station according to claim 5, wherein said predetermined period of time is set longer than a period in which the transmission power control is performed.

7. The radio station according to claim 5, comprising:
reception power determining means for determining whether a total reception power in a receive channel exceeds a predetermined threshold;
signal broadcasting means for, when the total reception power exceeds the threshold, broadcasting a transmission regulation signal for ordering a predetermined operation of regulating packet transmission, to neighbor radio stations; and
first transmission regulation controlling means for, when receiving the transmission regulation signal from another radio station during packet transmission, performing such control as to suspend transmission of a new packet or lengthen said predetermined period of time as a shift width of said transmission start times on the basis of the contents indicated by the transmission regulation signal.

8. A radio station having a function of transmitting and receiving packets on a wireless section to and from another radio station by code division multiple access and a function of performing transmission power control during transmission and reception of packets, said radio station comprising:
transmission rate controlling means for, on the occasion of continuously transmitting a plurality of packets, gradually increasing a transmission rate of each packet.

9. The radio station according to claim 8, comprising:
reception power determining means for determining whether a total reception power in a receive channel exceeds a predetermined threshold;
signal broadcasting means for, when the total reception power exceeds the threshold, broadcasting a transmission regulation signal for ordering a predetermined operation of regulating packet transmission, to neighbor radio stations; and
second transmission regulation controlling means for, when receiving the transmission regulation signal from another radio station during packet transmission, performing such control as to suspend transmission of a new packet or lower a transmission rate of a subsequent packet on the basis of the contents indicated by the transmission regulation signal.

10. A radio station having a function of transmitting and receiving packets on a wireless section to and from another radio station by code division multiple access and a function of performing transmission power control during transmission and reception of packets, said radio station comprising:
number-of-transmitted-packets controlling means for, on the occasion of concurrently and continuously transmitting a plurality of packets, gradually increasing the number of packets concurrently transmitted.

11. The radio station according to claim 10, comprising:
reception power determining means for determining whether a total reception power in a receive channel exceeds a predetermined threshold;
signal broadcasting means for, when the total reception power exceeds the threshold, broadcasting a transmission regulation signal for ordering a predetermined operation of regulating packet transmission, to neighbor radio stations; and
third transmission regulation controlling means for, when receiving the transmission regulation signal from another radio station during packet transmission, performing such control as to suspend transmission of a new packet or decrease the number of packets concurrently transmitted, on the basis of the contents indicated by the transmission regulation signal.
